(19) United States
(12) Patent Application Publication
(10) Pub. No.: US 2025/0197776 A1
(43) Pub. Date: Jun. 19, 2025

(54) CONCENTRATED DETERGENT COMPOSITIONS AND METHODS OF USING THE SAME

(71) Applicant: HENKEL AG & CO. KGAA, Düsseldorf (DE)

(72) Inventors: Daniel PIORKOWSKI, Fairfield, CT (US); Janet COOPE-EPSTEIN, Trumbull, CT (US)

(21) Appl. No.: 18/970,777

(22) Filed: Dec. 5, 2024

Related U.S. Application Data
(60) Provisional application No. 63/612,001, filed on Dec. 19, 2023.

(51) Int. Cl. C11D 3/22; C11D 1/00; C11D 1/29; C11D 1/72; C11D 1/831; C11D 3/20; C11D 3/30; C11D 3/33; C11D 3/386; C11D 3/43

(52) U.S. Cl. CPC C11D 3/221; C11D 1/831; C11D 3/2079; C11D 3/30; C11D 3/33; C11D 3/38618; C11D 3/38636; C11D 3/43; C11D 1/008; C11D 1/29; C11D 1/72

(57) ABSTRACT

Disclosed are detergent compositions having a sugar amine, a non-aqueous solvent, an alcohol ethoxylate non-ionic surfactant and water. The detergent compositions can have from about 0.01 to about 2 wt % of the sugar amine, from about 20 to about 50 wt % of the non-aqueous solvent, and from about 15 to about 40 wt % of the alcohol ethoxylate non-ionic surfactant. Advantageously, the detergent compositions can be free of one or all of propylene glycol, linear alkyl sulfonates and linear alkylbenzene sulfonates.

### CROSS REFERENCE TO RELATED APPLICATIONS

This application claims the benefit of U.S. Provisional Patent App. No. 63/612,001, filed Dec. 19, 2023, the disclosure of which is hereby incorporated by reference herein.

### FIELD OF THE INVENTION

This disclosure generally relates to liquid detergent compositions and methods of using the same. More specifically, this disclosure generally relates to liquid detergent compositions containing sugar amines.

### BACKGROUND

Liquid laundry detergent compositions contain surfactants to have good cleaning performance. However, many surfactant compositions cause skin and eye irritation. Consumers generally prefer mild liquid detergent formulations. While several products currently on the market claim to be mild, there is a still a need to develop improved mild liquid detergent formulations that have good cleaning performance.

### SUMMARY OF THE INVENTION

Various aspects of the present disclosure are directed to liquid detergent compositions and methods of using the same.

In some instances, a first aspect of the disclosure can be described as a liquid detergent composition comprising, consisting essentially of, or consisting of a sugar amine, a non-aqueous solvent, an alcohol ethoxylate, and water.

In some instances, a second aspect of the disclosure can be described as a liquid detergent composition according to the first aspect, wherein the detergent composition is free of one or both of propylene glycol, and linear alkylbenzene sulfonates.

In some instances, a third aspect of the disclosure can be described as a liquid detergent composition according to the first or second aspect, wherein the sugar amine is in an amount ranging from about 0.01 to about 2 wt % of the detergent composition, the fatty alcohol ethoxylate is in an amount ranging from about 15 to about 40 wt % of the detergent composition, and the alcohol ethoxylate non-ionic surfactant in an amount ranging from about 15 to about 40 wt % of the detergent composition.

In some instances, a fourth aspect of the disclosure can be described as a liquid detergent composition according to any one of the first through third aspects, wherein the sugar amine is a sugar alcohol amine, a sugar diamine, a salt thereof, or any combination of any of the foregoing.

In some instances, a fifth aspect of the disclosure can be described as a liquid detergent composition according to any one of the first though fourth aspects, wherein the sugar amine is a sorbitol amine, a glucosamine, a glucose diamine, glucosamine HCl, a salt thereof, or any combination of any of the foregoing.

In some instances, a sixth aspect of the disclosure can be described as a liquid detergent composition according to any one of the first through fifth aspects, wherein the non-aqueous solvent is glycerin, a polyethylene glycol, a glycol ether, or any combination thereof.

In some instances, a seventh aspect of the disclosure can be described as a liquid detergent composition according to any one of the first through sixth aspects, wherein the sugar amine is in an amount ranging from about 0.25 to about 0.75 wt % of the detergent composition.

In some instances, an eighth aspect of the disclosure can be described as a liquid detergent composition according any one of the first through seventh aspects, wherein the detergent composition further comprises a strong base. In some instances, the strong base is in an amount ranging from about 0.01 to about 2 wt % of the detergent composition.

In some instances, a ninth aspect of the disclosure can be described as a liquid detergent composition according to the first through eighth aspects, wherein the detergent composition further comprises a weak acid. In some instances, the weak acid is in an amount ranging from about 0.01 to about 2 wt % of the detergent composition.

In some instances, a tenth aspect of the disclosure can be described as a liquid detergent composition according to any one of the first through ninth aspects, wherein the detergent composition further comprises a chelating agent. In some instances, the chelating agent is in an amount ranging from about 0.1 to about 2.5 wt % of the detergent composition.

In some instances, an eleventh aspect of the disclosure can be described as a liquid detergent composition according to any one the first through tenth aspects, wherein the detergent composition further comprises a lauryl sulfate and/or a lauryl ether sulfate. In some instances, the lauryl sulfate and/or lauryl ether sulfate is in an amount ranging from about 2 to about 8 wt % of the detergent composition.

In some instances, a twelfth aspect of the disclosure can be described as a liquid detergent composition according to any of the first through eleventh aspects, wherein the detergent composition further comprises a fatty acid. In some instances, the fatty acid is in an amount ranging from about 0.5 to about 5 wt % of the detergent composition.

In some instances, a thirteenth aspect of the disclosure can be described as a liquid detergent composition according to any one of the first through twelfth aspects, wherein the detergent composition has a pH ranging from about 5 to about 12.

In some instances, a fourteenth aspect of the disclosure can be described as a liquid detergent composition according to the first through twelfth aspects, wherein the detergent composition has a pH ranging from about 7 to about 11.5.

In some instances, a fifteenth aspect of the disclosure can be described as a liquid detergent composition according to the first through fourteenth aspects, wherein the detergent composition further comprises ethanol and/or one or more glycol ethers.

In some instances, sixteenth aspect of the disclosure can be described as a liquid detergent composition according to the first through fifteenth aspects, wherein the detergent composition has a water activity ranging from about 0.55 to about 0.85.

In some instances, a seventeenth aspect of the disclosure can be described as a liquid detergent composition according to the first through sixteenth aspects, wherein the detergent composition has a water activity less than 0.7.

In some instances, an eighteenth aspect of the disclosure can be described as a liquid detergent composition according to the first through seventeenth aspects, wherein the detergent composition has a Zein score of less than 2%.

In some instances, a nineteenth aspect of the disclosure can be described as a liquid detergent composition according to the first through eighteenth aspects, wherein the detergent composition has a Zein score of less than 0.5%.

In some instances, a twentieth aspect of the disclosure can be described as a liquid detergent composition according to the first through nineteenth aspects, wherein the detergent composition further comprises a protease. In some instances, the protease is in an amount from about 0.01 to about 2 wt % of the detergent composition.

In some instances, a twenty-first aspect of the disclosure can be described as a liquid detergent composition according to the first through twentieth aspects, wherein the detergent composition further comprises an amylase. In some instances, the amylase is in an amount ranging from about 0.01 to about 2 wt % of the detergent composition.

In some instances, a twenty-second aspect of the disclosure can be described as a liquid detergent composition according to the first through twenty-first aspects, wherein the detergent composition can furth comprise a mannanase. In some instances, the mannanase is in an amount ranging from about 0.01 to about 2 wt % of the detergent composition.

In some instances, a twenty-third aspect of the disclosure can be described as a liquid detergent composition according to the first through twenty-second aspects, wherein the detergent composition has a pH ranging from about 6 to about 10.5.

In some instances, a twenty-fourth aspect of the disclosure can be described as a liquid detergent composition according to the first through twenty-third aspects, wherein the detergent composition has a pH ranging from about 7 to about 9.

In some instances, a twenty-fifth aspect of the disclosure can be described as a liquid detergent composition according to the first through twenty-fourth aspects, wherein the non-aqueous solvent is in an amount ranging from about 30 to about 40 wt % of the detergent composition.

In some instances, a twenty-sixth aspect of the disclosure can be described as a liquid detergent composition according to the first through twenty-fifth aspects, wherein the alcohol ethoxylate non-ionic surfactant is in an amount ranging from about 20 to about 35 wt % of the detergent composition.

In some instances, a twenty-seventh aspect of the disclosure can be described as a liquid detergent composition according to the first through twenty-fifth aspects, wherein the detergent composition is free of preservatives. Preservative-free liquid detergent compositions can also be referred to herein as “self-preserved” detergent compositions, meaning the inherent properties of the detergent compositions (such as, for example, water activity, pH, and relative ratios of components) provide for a liquid detergent composition that can be stored for commercially acceptable periods of time without compromising the integrity of the composition despite the absence of conventional, prior art, preservatives in the detergent composition.

In some instances, a twenty-eighth aspect of the disclosure can be described as a method of cleaning laundry comprising combing an amount of the detergent composition according to any one of the first aspect through twenty-seventh aspects with water to form a diluted detergent composition, and cleaning the laundry using the diluted detergent composition.

In some instances, a twenty-ninth aspect of the disclosure can be described as a method of cleaning laundry comprising combing an amount of the detergent composition according to any one of the first through twenty-seventh aspects with an amount of water to form a diluted detergent composition having from about 0.4 to about 0.8 grams of the detergent composition per liter of water, and cleaning the laundry using the diluted detergent composition.

### BRIEF DESCRIPTION OF THE DRAWINGS

In order that the present disclosure may be readily understood, aspects of the invention are illustrated by the way of examples in the accompanying drawings, in which like parts are referred to with like reference numeral throughout.

FIG. 1 is a graphical display showing the buffer capabilities of sugar amines compared to lysine and triethanolamine. The pH is measured as a function of NaOH addition to the solution.

### DETAILED DESCRIPTION

The following description of the instances is merely exemplary in nature and is in no way intended to limit the subject matter of the present disclosure, their application, or uses.

As used throughout, ranges are used as shorthand for describing each and every value that is within the range. Any value within the range can be selected as the terminus of the range. Unless otherwise specified, all percentages and amounts expressed herein and elsewhere in the specification should be understood to refer to percentages by weight.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively ±5 percent, alternatively ±1 percent, alternatively ±0.5 percent, and alternatively ±0.1 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the present invention.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

Various aspects of the disclosure are directed to laundry detergent concentrates that do not contain a preservative, that are 2- to 4-times more concentrated than standard detergents (an exemplary one is 1.5 fluid ounces per dose).

Various aspects of the present disclosure are directed towards self-preserved laundry detergent compositions and methods of use. Self-preserved laundry detergent compositions according to the disclosure are free of one or both of propylene glycol and linear alkylbenzene sulfonates. Propylene glycol, while regularly used in many prior art laundry detergents, may induce allergic in some users, as it can cause irritant contact dermatitis, urticaria, eczematous eruptions and sensory irritation. Linear alkylbenzene sulfonates are also regularly used in many prior art laundry detergents as surfactants. Linear alkylbenzene sulfonates, however, are not generally known as mild surfactants.

In accordance with various aspects of the disclosure, certain detergent compositions comprise, consistent essentially of, or consist of a sugar amine, a non-aqueous solvent, an alcohol ethoxylate non-ionic surfactant, and water. In some instances, the detergent composition is free of one or both of propylene glycol and linear alkylbenzene sulfonates. In some instances, the detergent composition is free of preservatives. Preferably, detergent compositions according to various aspects of the present disclosure are free of propylene glycol, linear alkylbenzene sulfonates and any other preservatives that to date have traditionally been used in detergent compositions.

In accordance with various aspects of the disclosure, the inventors have discovered the use of sugar amines in laundry detergent compositions serves at least two important purposes. First, sugar amines have been discovered to serve as effective pH buffers in liquid detergent compositions, whether used alone or in combination with other commonly used pH buffers such as, for example, triethanolamine. Second, the inventors have discovered that sugar amines serve as effective chlorine scavengers when used in laundry detergent compositions. This is of importance since wash water (especially water from municipal sources) contains chlorine as a sanitization agent against microbes. Chlorine deteriorates dyes in fabrics over time, which may be observed (by, for example, reduced color saturation or intensity exhibited by the fabric) in 30 washes or less if not controlled. In addition to fabric dye damage, chlorine can negatively impact the cleaning performance of enzymes that may be present in laundry detergent compositions. As such, the use of sugar amines as a chlorine scavenger can help enhance enzyme cleaning performance and thus the overall cleaning efficiency of the laundry detergent composition.

Further, a suitable pH buffer is of importance to provide manufacturing facilities more flexibility for production, so it is much easier to hit the target pH, even if materials are added within a standard deviation of a target amount (for example ±2%). The inventors found the use of sugar amines can be effective in buffering liquid detergent compositions at various pH values including those in the 7 to 8 range, which is ideal for enzyme containing formulations. Within its buffer range, sugar amines can provide dual benefits (buffering and chlorine scavenging), whereas outside of the buffer range, it provides a chlorine scavenging benefit.

As used herein, the term “sugar amine” is directed to a broad class of compounds. In some instances, sugar amines suitable for use in liquid detergent compositions according to the disclosure are monosaccharides, in cyclic or open chain form, where at least three, alternatively at least two, alternatively at least one, alternatively three, alternatively two, alternatively one, and preferably one, hydroxyl group has been substituted with a secondary or primary amine, preferably a primary amine. Example monosaccharides include, but are not limited to glucose, fructose, galactose, mannofuranose (i.e., mannose in five-membered ring form) and mannopyranose. By extension example sugar amines having a monosaccharide base structure may include, for example, glucosamine, galactosamine, N-acetylglucosamine, duanosamine, frustosamine, mannosamines, glucose diamines (for example, 2,6-diamino-2,3,6-trideoxy-alpha-D-glucose), and so on.

In some instances, sugar amines suitable for use in liquid detergent compositions according to the disclosure are sugar alcohols where at least three, alternatively at least two, alternatively at least one, alternatively three, alternatively two, alternatively one, and preferably one, hydroxyl group of the sugar alcohol has been substituted with a secondary or primary amine, preferably a primary amine. Example sugar alcohols include, but are not limited to sorbitol, xylitol, mannitol, erythritol, threitol, arabitol, ribitol, galactitol, fucitol, iditol, inositol, volemitol, maltitol, and lactitol. By extension example sugar alcohol amines may include, for example, sorbitol amine, mannitol amine, and so on.

In some instances, sugar amines suitable for use in liquid detergent compositions according to the disclosure are disaccharides where at least three, alternatively at least two, alternatively at least one, alternatively three, alternatively two, alternatively one, and preferably one, hydroxyl group on one or both saccharide units has been substituted with a secondary or primary amine, preferably a primary amine. Example disaccharides include, but are limited to sucrose, lactose, maltose, trehaloses, cellobiose, chitobiose, kojibiose, nigerose, isomaltose, sophorose, laminaribiose, gentiobiose, trehalulose, turanose, maltulose, leucrose, isomaltulose, gentiobiulose, mannobiose, melibiose, allolactose, melibiulose, lactulose, rutinose, rutinulose and xylobiose. By extension example sugar amines having a disaccharide base structure may include, for example, lactosamine, N-acetyllactosamine, trehalosamines (for example, 2-trehalosamine, 3-trehalosamine and 4-trehalosamine), a glucosamine disaccharide form of chitobiose, an N,N′-diacetylglucosamine dimer form of chitobiose, and so on.

In some instances, detergent compositions according to various aspects of the disclosure may include a sugar amine in an amount ranging from about 0.01 to about 2 wt % of the detergent composition. In some instances, the sugar amine can be in an amount ranging from about 0.01 to about 6 wt %, alternatively from about 0.01 to about 5 wt %, alternatively from about 0.01 to about 4 wt %, alternatively from about 0.01 to about 3 wt %, and alternatively from about 0.01 to about 2.5 wt % of the detergent composition. In yet other instances, the sugar amine can be in an amount ranging from about 0.05 to about 1.75 wt %, alternatively from about 0.1 to about 1.5 wt %, alternatively from about 0.15 to about 1.25 wt %, alternatively from about 0.2 to about 1 wt %, and alternatively from about 0.25 to about 0.75 wt % of the detergent composition. The sugar amine can be any compound as described above, a salt thereof, or any combination one or more sugar amines and/or sugar amine salts. In some instances, the use of glucosamine, sorbitol amine, glucose diamines, salts thereof, or any combination of any of the foregoing as the sugar amine may be preferred. In some instances, the use of glucosamine HCl as the sugar amine may be preferred.

In some instances, detergent compositions according to various aspects of the disclosure may include a non-aqueous solvent in amount ranging from about 20 to about 50 wt % of the detergent composition. In some instances, the non-aqueous solvent is in an amount from about 10 to about 70 wt %, alternatively about 15 to about 60 wt %, and alternatively about 20 to about 55 wt % of the detergent composition. In some instances, the non-aqueous solvent is in an amount from about 30 to about 50 wt %, alternatively about 30 to about 40 wt %, and alternatively about 40 to about 50 wt % of the detergent composition. Generally, a non-aqueous solvent that is not traditionally considered a preservative when used in liquid detergent compositions is suitable. In some instances, the non-aqueous solvent of the detergent composition is glycerin, a polyethylene glycol, a glycol ether, or any combination thereof. In some instances, the non-aqueous solvent is glycerol (glycerin), ethylene glycol, ethanol, or a 4C+ compounds. The term “4C+ compound” refers to one or more of: polyethylene glycol esters such as polyethylene glycol stearate, propylene glycol laurate, and/or propylene glycol palmitate; ethyl ester ethoxylate; diethylene glycol; dipropylene glycol; tetramethylene glycol; butylene glycol; pentanediol; hexylene glycol; heptylene glycol; octylene glycol; 2-methyl-1,3-propanediol; triethylene glycol; glycol ethers, such as ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether; tris (2-hydroxyethyl)methyl ammonium methylsulfate; ethylene oxide/propylene oxide copolymers with a number average molecular weight of 3,500 Daltons or less; and ethoxylated fatty acids. In some instances, the non-aqueous solvent is or includes a relatively low molecular weight polyethylene glycol (PEG). In some instances, the polyethylene glycol has a molecular weight ranging from about 200 to about 1000 g/mol (or Daltons), alternatively a molecular weight ranging from about 200 to about 800 g/mol, or alternatively a molecular weight of about 400 g/mol. In some instances, the polyethylene glycol has a weight average molecular weight of less than about 600 Da, e.g. about 400, such as those having a weight average molecular weight of from about 380 to about 420 Da. In other instances, PEG 200, PEG 250, PEG 300, PEG 350, PEG 400, PEG 450, PEG 500, PEG 550, and/or PEG 600 (wherein the numerals represent the approximate weight average molecular weight in Daltons or grams/mol) may be used. In some instances, the non-aqueous solvent is or includes an ethylene oxide/propylene oxide block copolymer. In some instances, the non-aqueous solvent is or includes a polyol such as glycerin. In some instances, the non-aqueous solvent is or includes a mixture of a polyol and a polyethylene glycol. In some instances, the polyol in the mixture is glycerin. Suitable polyol/polyethylene glycol mixtures may have a polyol to polyethylene glycol weight:weight ratio ranging from about 10:1 to about 1:10, alternatively from about 9:1 to about 1:9, alternatively from about 8:1 to about 1:8, alternatively from about 7:1 to about 1:7, alternatively from about 6:1 to about 1:6, alternatively from about 5:1 to about 1:5, alternatively from about 4:1 to about 1:4, alternatively from about 3:1 to about 1:3, alternatively from about 2:1 to about 1:2, alternatively from about 1.5:1 to about 1:1.5, and alternatively about 1:1

In some instances, detergent compositions according to various aspects of the disclosure may include an alcohol ethoxylate non-ionic surfactant in an amount ranging from about 15 to about 35 wt % of the detergent composition. In some instances, the alcohol ethoxylate non-ionic surfactant is in an amount ranging from about 10 to about 50 wt %, alternatively from about 10 to about 45 wt %, alternatively from about 10 to about 40 wt %, alternatively from about 15 to about 30 wt %, and alternatively from about 20 to about 30 wt % of the detergent composition. Suitable alcohol ethoxylates include, but are not limited to, those having alkyl chains of from C₈-C₃₅, alternatively C₈-C₂₄, alternatively C₈-C₁₈, and alternatively C₁₀-C₁₈ carbon atoms, and 3 to 9 ethylene oxide units located between the alkyl chain and the terminal alcohol group. In some instances, alkyl polyglucosides (APG) can be used as a non-ionic surfactant, in detergent compositions according to various aspects of the disclosure, in combination with, or instead of the alcohol ethoxylate non-ionic surfactant. Suitable alkyl polyglucosides include, but are not limited to, those having from C₈-C₃₅, alternatively C₈-C₂₄, alternatively C₈-C₁₈, alternatively C₈-C₁₂ and alternatively C₈-C₁₀ carbon atoms between the alkyl chain and the terminal alcohol group. In some instances a mixture of alkyl polyglucosides such as, for example a mixture of caprylyl and decyl glucoside, can be used.

In some instances, the detergent composition according to various aspects of the disclosure may further comprise a strong base. In some instances, the strong base is in an amount of about 0.01 to about 2 wt % of the detergent composition. In some instances, the strong base is in an amount of from about 0.01 to about 5 wt %, alternatively from about 0.01 to about 3 wt %, alternatively about 0.01 to about 1 wt %, and alternatively from about 0.05 to about 0.5 wt % of the detergent composition. In some instances, the strong base can be, for example, potassium hydroxide, sodium hydroxide, or calcium hydroxide. Generally, any amount of strong base may be added to a detergent composition to provide said detergent composition with a target end property such as, for example, pH.

In some instances, the detergent composition according to various aspects of the disclosure may further comprise a weak acid. In some instances, the weak acid is in an amount ranging from about 0.01 to about 2 wt % of the detergent composition. In some instances, the weak acid is in an amount of from about 0.01 to about 5 wt %, alternatively from about 0.01 to about 3 wt %, alternatively about 0.01 to about 1 wt %, and alternatively from about 0.05 to about 0.5 wt % of the detergent composition. In some instances, the weak acid can be, for example, citric acid, acetic acid, lactic acid, stearic acid, palmitic acid, or oleic acid. Generally, any amount of weak acid may be added to a detergent composition to provide said detergent composition with a target end property such as, for example, pH.

In some instances, the detergent composition according to various aspects of the disclosure may further comprise a chelating agent. In some instances, the chelating agent is in an amount ranging from about 0.1 to about 2.5 wt % of the detergent composition. In some instances, the chelating is in an amount ranging from about 0.01 to about 3 wt %, alternatively about 0.5 to about 2.5 wt %, alternatively about 1 to about 2 wt % of the detergent composition. In some instances, the chelating agent is iminodisuccinic acid. In some instances, the chelating agent is in an amount ranging from about 0.1 to about 2 wt % of the detergent composition. In some instances the chelating agent is ethylenediaminetetraacetic acid (EDTA), nitrilotriacetic acid, diethylenetriaminepenta(methylenephosphonic acid), nitrilotris(methylenephosphonic acid), 1-hydroxyethane-1,1-diphosphonic acid, ethylenediamine-N,N′-disuccinic acid (EDDS), hydroxyethylenediaminetriacetic acid (HEDTA), N,N-bis(carboxymethyl)-L-glutamic acid tetrasodium salt, Alanine, N,N-bis(carboxymethyl)-alanine, trisodium salt or other chelating compounds.

In some instances, the detergent composition according to various aspects of the disclosure may further comprise a lauryl sulfate or a lauryl ether sulfate. In some instances, the lauryl sulfate or lauryl ether sulfate is in an amount ranging from about 2 to about 8 wt % of the detergent composition. In some instances, the lauryl sulfate or lauryl ether sulfate is in an amount ranging from about 1 to about 10 wt %, alternatively about 3 to about 8 wt %, alternatively about 2.5 to about 7.5 wt % of the detergent composition. When lauryl ether sulfates are used, they preferably have between two and six repeating ethylene oxide units, more preferably between two and five repeating ethylene oxide units, and even more preferably between two and four repeating ethylene oxide units. In certain instances, the lauryl ether sulfates having three repeating ethylene oxide units is particularly preferred.

In some instances, the detergent composition according to various aspects of the disclosures may further comprise a fatty acid. In some instances, the fatty acid is in an amount from about 0.5 to about 5 wt % of the detergent composition. In some instances, the fatty acid is in an amount from about 0.1 to about 7 wt %, alternatively about 0.5 to about 6 wt %, alternatively about 0.5 to about 4, alternatively about 0.5 to about 3 wt % of the detergent composition. In some instances, the fatty acid is coconut fatty acid. In some instances, the fatty acid is lauric acid, myristic acid, palmitic acid, stearic acid, ricinoleic acid, oleic acid, linoleic acid, or linolenic acids.

In some instances, the detergent composition according to various aspects of the disclosure further comprises ethanol or denatured ethanol. In some instances, the denatured alcohol is a denatured alcohol ranging from 140 to 200 proof, alternatively from 160 to 200 proof, and alternatively from 180 to 200 proof. In some instances, the denatured alcohol is in an amount ranging from about 0.5 to about 6 wt % of the detergent composition. In some instances, the denatured alcohol is in an amount ranging from about 1 to about 5 wt %, alternatively from about 2 to about 4 wt %, and alternatively from about 2.5 to about 3.5 wt % of the detergent composition.

In some instances, detergent compositions according to various aspects of the disclosure further comprises an effective amount of one or more glycol ethers.

In some instances, the detergent composition according to various aspects of the disclosure, wherein the detergent composition is free of preservatives. In some instances, examples of preservatives that would not be present in detergent compositions according to various aspects of the disclosure include, but are not limited to, methylisothiazolinone, chloromethylisothiazolinone, benzisothiazolinone, sorbic acid, sodium benzoate, formaldehyde, borate, and glutaraldehyde.

In some instances, detergent compositions according to various aspects of the disclosure further comprise an aqueous enzyme solution comprising a cocktail of one or more enzymes. In some instances, the one or more enzymes may include, for example, one or more of an amylase, a protease and a mannanase. In some instances, the protease is in an amount ranging from about 0.01 to about 2 wt % of the detergent composition. In some instances, the amylase is in an amount ranging from about 0.01 to about 2 wt % of the detergent composition. In some instances, the mannanase is in an amount ranging from about 0.01 to about 2 wt % of the detergent composition.

In some instances, the detergent composition according to various aspects of the disclosure has a pH ranging from about 5 to about 12. In some instances, the detergent composition has a pH ranging from about 7 to about 11.5, alternatively the pH ranges from about 6 to about 10.5, or alternatively pH ranges from about 7 to about 9. In some instances, it has been found that detergent compositions having a pH ranging from about 7 to about 9 are preferred in instances where a detergent composition includes one or more enzymes, as such pH range has been observed to enhance enzyme stability.

In some instances, the detergent composition according to various aspects of the disclosure has a water activity ranging from about 0.55 to about 0.85. In some instances, the detergent composition has a water activity of less than 0.7. In some instances, the detergent composition has a water activity ranging from about 0.5 to about 0.9, alternatively from about 0.6 to about 0.8, or alternatively from about 0.55 to about 0.8.

In some instances, aspects of this disclosure are directed towards a method of cleaning laundry, the method comprising, combining an amount of a detergent composition with an amount of water to form a diluted detergent composition having from about 0.1 to grams to about 1.5 grams, preferably from about 0.2 to about 1.25 grams, more preferably from about 0.3 to about 1 gram, and more preferably from about 0.4 to about 0.8 grams of the detergent composition per liter of water; and cleaning the laundry using the diluted detergent composition.

As used herein the phrase “Zein score” refers the measurement obtained from the Zein test as described in the Examples. It can also be referred to as “Zein solubilized %.” In some instances, the formulations described herein have a Zein score of less than about 3% when tested as a 10% dilution. In certain instances, the formulations have a Zein score of from about 0.01% to about 3%, from about 0.01% to about 2.75%, from about 0.01% to about 2.5%, from about 0.01% to about 2.25%, from about 0.01% to about 2%, from about 0.01% to about 1.75%, from about 0.01% to about 1.5%, from about 0.01% to about 1.25%, or from about 0.01% to about 1% when tested as a 310% dilution. In other instances, the formulations described herein can have a Zein score of less than about 2.75%, less than about 2.5%, less than about 2.25%, less than about 2%, less than, 1.75%, less than about 1.5%, less than about 1.25%, or less than about 1% when tested as a 10% dilution.

In some instances, the detergent composition according to various aspects of the disclosures has a Zein score less than 0.5%. In some instances, the detergent composition has a Zein score ranging from about 0.3 to about 0.4%. In some instances, the detergent composition has a Zein score of less than 2%. The Zein score is used in these instances as a measurement of how mild the laundry detergent is as explained in the examples.

In some instances, Glycerin is preferred since it is commonly found in the food industry, can be naturally derived from plants (if that is desired vs petrol-sourced), is the most cost effective, and binds the most water, which lowers water activity the most and allows additional water to be added to the formula. In some instances, 70% PEG400 can lead to a water activity of 0.76 in the detergent composition. In some instances, 70% propylene glycol can lead to a water activity of 0.65 in the detergent composition. In some instances, 70% sorbitol can lead to a water activity of 0.75 in the detergent composition. In some instances, 70% glycerin can lead to a water activity of 0.62 in the detergent composition.

In some instances, the disclosure is directed towards a method of cleaning laundry, the method comprising: combining an amount of the detergent composition of claim 1 to an amount of water to form a diluted detergent composition having from about 0.4 to about 0.8 grams of the detergent composition per liter of water, and cleaning the laundry using the diluted detergent composition. In some instances, the diluted detergent composition has about 0.3 to about 0.9 grams of the detergent composition per liter of water.

As used herein the phrase “Zein score” refers the measurement obtained from the Zein test as described herein. It can also be referred to as “Zein solubilized %.” In some instances, the formulations described herein have a Zein score of less than about 3% when tested as a 10% dilution. In certain instances, the formulations have a Zein score of from about 0.01% to about 3%, alternatively from about 0.01% to about 2.75%, alternatively from about 0.01% to about 2.5%, alternatively from about 0.01% to about 2.25%, alternatively from about 0.01% to about 2%, alternatively from about 0.01% to about 1.75%, alternatively from about 0.01% to about 1.5%, alternatively from about 0.01% to about 1.25%, and alternatively from about 0.01% to about 1% when tested as a 10% dilution. In other instances, the formulations described herein can have a Zein score of less than about 2.75%, preferably less than about 2.5%, more preferably less than about 2.25%, even more preferably less than about 2%, even more preferably less than 1.75%, even more preferably less than about 1.5%, even more preferably less than about 1.25%, and even more preferably less than about 1% when tested as a 10% dilution.

In some instances, the detergent composition has a Zein score less than 0.5%. In some instances, the detergent composition has a Zein score ranging from about 0.3 to about 0.4%. The Zein score is used in these instances as a measurement of how mild the laundry detergent is as explained in the examples.

One method to test the skin irritancy potential of a surfactant composition is Zein test. Zein score is measured using a Zein test (Gott, E., Aesthet. Medzin., Tenside 15:313 (1966)). Zein test determines the extent of denaturation of Zein corn protein after exposure to a surfactant for a given period of time. Generally, the higher the Zein score, the greater the skin irritation potential.

Another method to measure the skin irritancy potential is corneosurfametry (CSM) test, a noninvasive quantitative test that measures the interaction between surfactants and human stratum corneum (Pierard et al., Dermatology 189:152-156 (1994)). Corneosurfametry involves removing a few layers of skin using cyanoacrylate skin surface strippings, short contact time with surfactants followed by staining the samples with fuchian dyes. A less damaged barrier allows greater penetration of the stain, therefore giving a more intense color, which is measured using colorimetrically with L*a*b* color space. This method is predictive of both protein and lipid damage in the skin. CIM (Color Indicator of Mildness) values are obtained from a corneosurfametry test. In a comparative study, the higher the CIM value, the milder the surfactant formulation.

A third method to evaluate the irritation effect of a surfactant formulation is measured by cytokine release of representative human skin model in response to the surfactant formulation. Where skin tissue viability is not decreased by 50% as compared to the negative control tissue (as measured by MTT reduction), the inflammatory potential is then measured by the production of the cytokines IL-1a. and/or IL-1ra. MTT is a dye used to stain the skin cells called 3-(4,5-dimethylthiazol-2-yl)-2,5-diphenyltetrazolium bromide. In a comparative study, a lower cytokine release value means a milder surfactant formulation.

Described in US 2018/0016523, the entire contents of which are incorporated by reference herein, are methods for determining how mild an aqueous laundry detergent formulation is for a user. The method comprises the steps of: (i) providing a solution comprising a laundry cleaning effective amount of a surfactant composition, (ii) subjecting an appropriate dilution of the solution to Zein test, corneosurfametry test, and in vitro cytokine release test for IL-1a and IL-1ra response, respectively, to obtain a Zein score, a corneosurfametric (CSM) value, and a cytokine release value, and (iii) deriving at composite mildness indicator (CMI) for each solution based the Zein score, the CSM value, and the cytokine release value.

The composite mildness indicator (CMI) may also be called detergent mildness indicator (DMI). Specifically, the CMI can be derived from (1) the Zein score, CSM value, and cytokine release value IL-1a of the formulation; (2) the Zein score, CSM value, and cytokine release value (IL-1a+IL-1ra) of the formulation; (3) the Zein score, CSM value, and cytokine release value (IL-1ra/IL-1a) of the formulation; (4) the Zein score, CSM value, and cytokine release value log 10 (IL-1ra/IL-1a) of the formulation; or (5) the Zein score, CSM value, and cytokine release measurement (IL-1a/IL-1ra) of the formulation.

### EXAMPLES

### Example 1—Laundry Detergents with Monoethanolamine

Unit dose example: The following laundry detergent compositions were created, each with a target pH of 7.7, using a standard overhead mixer, a blend of Polyethylene Glycol (400 g/mol) and Glycerin was used as listed in Table 1. Formulation 4 was created as a control to compare against. Formulations 1-4 and their components (all amounts are in their wt %) are listed below in Table 1. Inventive Formulations 1-3 are free of propylene glycol, linear alkyl sulfonates and linear alkylbenzene sulfonates, whereas Comparative Formulation 4 contains propylene glycol and a linear alkylbenzene sulfonic acid.

TABLE 1

| | Activity | | Formulation | | |
|---|---|---|---|---|---|
| | of Raw | Formulation | 2 | Formulation | Formulation 4 |
| Component | Material | 1 (Inventive) | (Inventive) | 3 (Inventive) | (Comparative) |
| Glycerin | 99+% | 19.23 | 18.37 | 17.27 | 14.73 |
| Alcohol Ethoxylate | 99+% | 24.13 | 24.13 | 24.13 | 23.07 |
| Nonionic Surfactant, | | | | | |
| 7 mol EO | | | | | |
| Propylene glycol | 99+% | 0 | 0 | 0 | 8.21 |
| Polyethylene Glycol | 99+% | 28.85 | 27.56 | 25.91 | 5.8 |
| (400 g/mol) | | | | | |
| Monoethanolamine | 99+% | 1.4 | 1.4 | 1.4 | 4.80 |
| Water | 100 | 10.5 | 10.5 | 10.5 | 10.5 |
| Sodium Laureth | 70 | 4.8 | 4.8 | 4.8 | 4.8 |
| Sulfate, 3 mole EO | | | | | |
| Sodium Sulfite 15% | N/A | 8.08 | 8.08 | 8.08 | 7.98 |
| Solution, Bittering | | | | | |
| Agent (25% | | | | | |
| Solution), | | | | | |
| Iminidisuccinic | | | | | |
| Acid (34% | | | | | |
| Solution), Coconut | | | | | |
| Fatty Acid, Optical | | | | | |
| Brightener | | | | | |
| Polyethyleneimine | 80 | 0 | 0 | 6 | 0 |
| Ethoxylate Polymer | | | | | |
| (80% Active) | | | | | |
| Amylase, Protease, | 100 | 0 | 2.15 | 2.15 | 0 |
| Mannanase Enzyme | | | | | |
| Solutions | | | | | |
| SDA-3C Ethanol | 100 | 3 | 3 | 3 | 3 |
| (200 Proof) | | | | | |

Formulations 2 and 4 were also tested stain removal performance against a variety of stains (18.8 grams of each formulation). The following results were observed using a high efficiency top-loading laundry washing machine with the washing water at 59° F. (cold water) and 90° F. (warm water). The “Stain Removal Index” (or SRI) was used to measure stain differences with only significant removals illustrated Table 2 below. Two different types of fabric were used for these experiments: a knitted cotton (KC) and a polyester fabric (Poly).

TABLE 2

| | | 90° F. Water | | | 59° F. Water | | |
|---|---|---|---|---|---|---|---|
| | | SRI | | Δ SRI | SRI | | Δ SRI |
| | | Formulation | Formulation | (Form. 2 − | Formulation | Formulation | (Form. 2 − |
| | | 4 | 2 | Form. 4) | 4 | 2 | Form. 4) |
| Blood | KC | 80.88 | 84.06 | 3.17 | 80.66 | 81.56 | 0.90 |
| | Poly | 95.79 | 98.52 | 2.73 | 98.54 | 98.86 | 0.32 |
| Chocolate | KC | 83.98 | 94.06 | 10.08 | 84.02 | 89.22 | 5.21 |
| Ice | | | | | | | |
| Cream | | | | | | | |
| Coffee | Poly | 96.69 | 97.89 | 1.20 | 96.89 | 97.59 | 0.71 |
| Graph | Poly | 94.52 | 95.89 | 1.37 | 95.00 | 95.46 | 1.46 |
| juice | | | | | | | |
| Grass | KC | 63.99 | 66.27 | 2.28 | 63.07 | 64.61 | 1.54 |
| | Poly | N/A | N/A | N/A | 78.65 | 71.25 | −7.40 |
| Mud | Poly | 94.83 | 95.70 | 0.87 | N/A | N/A | N/A |

### Zein Test

The test surfactant solution can be a solution with 3% active surfactant, or a 10% dilution of a surfactant formulation/product which has a total surfactant concentration of about 10%-25%. In some instances, concentrated laundry detergents uses a test surfactant solution with 3% active surfactant, or a 3% dilution of a surfactant formulation/product which has a total surfactant concentration of about 10%-25%. Zein protein was added to an appropriate amount of the test surfactant solution so that some solids remained undissolved. The mixture was stirred for one hour. Undissolved Zein was then removed by filtration. A 3 mL aliquot of the filtered denatured solution was then analyzed for the weight of solids by drying the solution in an oven at 70° C. the weight of solids in a 3 mL aliquot of the test surfactant solution (in the absence of Zein) was also measured by drying the solution. The quantity of dissolved Zein in the Zein/surfactant solution was then calculated by difference and reported as a g Zein/100 g surfactant solution (also called “% Zein” or “Zein score”).

Alternatively, undissolved Zein can be removed by filtration and undissolved solids are measured gravimetrically. The amount of dissolved Zein remaining in the filtrate is calculated by different, and reported as g Zein/100 g surfactant solution. In a comparative study, the lower the dissolved Zein, the milder the product.

Formulations 1 and 4 were tested for Zein Scores:

Per US 2018/0016523, incorporated by reference, Zein score was obtained using the method described in paragraph 3 of the application and is as followed:

“One method to test the skin irritancy potential of a surfactant composition is Zein test. Zein score is measured using a Zein test (Gott, E., Aesthet. Medzin., Tenside 15: 313 (1966)). Zein test determines the extent of denaturation of Zein corn protein after exposure to a surfactant for a given period of time. Generally, the higher the Zein score, the greater the skin irritation potential.”

Formulation 4 received a Zein score of 2.27% (i.e., 2.27% of the Zein was dissolved, with a lower score being preferred) and Formulation 1 receiving a score of 0.325%. After performing a Tukey Analysis, the scores are significantly different from one another, and Formulation 1 is much preferred over Formulation 4 as a more mild detergent on skin.

### Example 2—Sugar Amines Act as pH Buffers

Monoethanolamine has been observed to suitably buffer solutions from a pH 7 to 9. As observed in the example below, Glucosamine buffers from pH 6.9 to 8.6. The following example compares the buffering ability of TEA, Glucosamine and Lysine (pH 9-10).

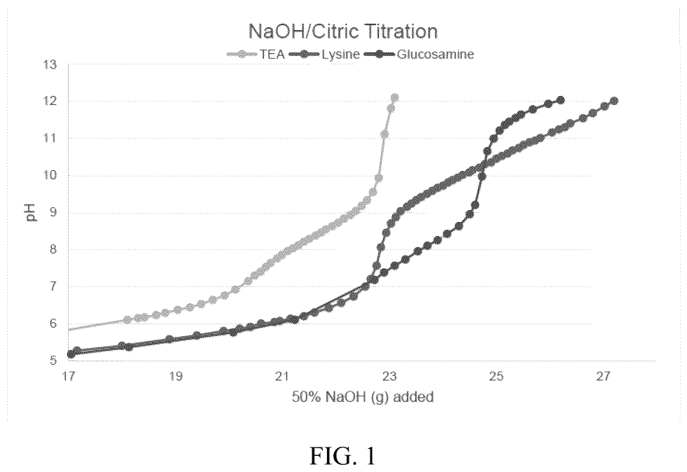

Three solutions of 350 grams of deionized water, 35 grams of 50% citric acid in water, and then 5 grams of active triethanolamine (TEA), lysine (from Lysine HCl (99% active)), and Glucosamine (from Glucosamine HCl (99% Active)) were prepared for a titration with 50% NaOH in water. This system simulates the main acidic and basic components of a liquid laundry detergent to measure what pH Glucosamine can buffer effectively compared to the historical use of triethanolamine. The following results were observed, as set forth in Table 3 and FIG. 1

TABLE 3

| TEA | | Lysine HCl | | Glucosamine HCl | |
|---|---|---|---|---|---|
| 50% | | 50% | | 50% | |
| NaOH | | NaOH | | NaOH | |
| Added (g) | pH | Added | pH | Added | pH |
| 2.87 | 3.35 | 1.36 | 2.58 | 2.28 | 2.5 |
| 5.16 | 3.78 | 2.5 | 2.76 | 5.6 | 3.19 |
| 7.55 | 4.21 | 3.9 | 3 | 7.23 | 3.51 |
| 10 | 4.59 | 5.24 | 3.25 | 9.62 | 3.95 |
| 12.55 | 5 | 6.5 | 3.47 | 12.5 | 4.42 |
| 15.39 | 5.44 | 7.6 | 3.67 | 15.44 | 4.90 |
| 18.1 | 6.1 | 9.1 | 3.94 | 17.05 | 5.17 |
| 18.3 | 6.15 | 10.17 | 4.12 | 18.13 | 5.36 |
| 18.42 | 6.17 | 11.75 | 4.38 | 20.08 | 5.76 |
| 18.64 | 6.23 | 12.6 | 4.51 | 21.23 | 6.10 |
| 18.81 | 6.29 | 14 | 4.73 | 22.72 | 7.18 |
| 19.04 | 6.37 | 15.4 | 4.97 | 22.9 | 7.38 |
| 19.27 | 6.44 | 16.16 | 5.1 | 23.1 | 7.56 |
| 19.48 | 6.53 | 17.16 | 5.27 | 23.3 | 7.73 |
| 19.7 | 6.64 | 18 | 5.4 | 23.53 | 7.95 |
| 19.92 | 6.76 | 18.89 | 5.58 | 23.71 | 8.10 |
| 20.12 | 6.92 | 19.4 | 5.68 | 23.9 | 8.25 |
| 20.36 | 7.15 | 19.9 | 5.8 | 24.08 | 8.42 |
| 20.48 | 7.3 | 20.2 | 5.86 | 24.3 | 8.63 |
| 20.59 | 7.4 | 20.4 | 5.91 | 24.5 | 8.95 |
| 20.69 | 7.53 | 20.6 | 6 | 24.6 | 9.20 |
| 20.78 | 7.64 | 20.85 | 6.04 | 24.73 | 9.97 |
| 20.9 | 7.76 | 20.95 | 6.07 | 24.83 | 10.65 |
| 20.99 | 7.85 | 21.15 | 6.13 | 24.95 | 10.99 |
| 21.1 | 7.96 | 21.4 | 6.2 | 25.06 | 11.21 |
| 21.2 | 8.04 | 21.6 | 6.3 | 25.16 | 11.36 |
| 21.3 | 8.12 | 21.87 | 6.42 | 25.24 | 11.45 |
| 21.4 | 8.21 | 22.1 | 6.56 | 25.36 | 11.55 |
| 21.5 | 8.29 | 22.33 | 6.73 | 25.46 | 11.64 |
| 21.62 | 8.38 | 22.55 | 7 | 25.68 | 11.78 |
| 21.72 | 8.46 | 22.65 | 7.2 | 25.97 | 11.93 |
| 21.81 | 8.54 | 22.76 | 7.56 | 26.2 | 12.03 |
| 21.93 | 8.63 | 22.84 | 8.06 | | |
| 22.04 | 8.72 | 22.94 | 8.45 | | |
| 22.15 | 8.83 | 23.03 | 8.7 | | |
| 22.27 | 8.93 | 23.12 | 8.87 | | |
| 22.37 | 9.04 | 23.21 | 9.03 | | |
| 22.48 | 9.18 | 23.33 | 9.15 | | |
| 22.58 | 9.33 | 23.41 | 9.24 | | |
| 22.69 | 9.55 | 23.5 | 9.33 | | |
| 22.8 | 9.93 | 23.59 | 9.41 | | |
| 22.91 | 11.11 | 23.7 | 9.5 | | |
| 23.03 | 11.81 | 23.8 | 9.58 | | |
| 23.1 | 12.1 | 23.9 | 9.66 | | |
| | | 24 | 9.72 | | |
| | | 24.1 | 9.81 | | |
| | | 24.18 | 9.87 | | |
| | | 24.28 | 9.94 | | |
| | | 24.37 | 10.01 | | |
| | | 24.49 | 10.08 | | |
| | | 24.55 | 10.14 | | |
| | | 24.68 | 10.21 | | |
| | | 24.78 | 10.3 | | |
| | | 24.9 | 10.35 | | |
| | | 25 | 10.45 | | |
| | | 25.1 | 10.52 | | |
| | | 25.21 | 10.59 | | |
| | | 25.3 | 10.67 | | |
| | | 25.42 | 10.74 | | |
| | | 25.51 | 10.82 | | |
| | | 25.62 | 10.89 | | |
| | | 25.72 | 10.94 | | |
| | | 25.82 | 11.01 | | |
| | | 26.04 | 11.16 | | |
| | | 26.17 | 11.24 | | |
| | | 26.28 | 11.3 | | |
| | | 26.38 | 11.4 | | |
| | | 26.62 | 11.54 | | |
| | | 26.8 | 11.68 | | |
| | | 27.02 | 11.86 | | |
| | | 27.2 | 12.01 | | |

### Example 3—Sugar Amines Act as Chlorine Scavengers in Laundry Detergents

Table 4 listed below are laundry detergents comprising sugar amines in different concentrated formulations. Formulation 5 is a 2× concentrated detergent composition comprising sugar amines. Formulation 6 is a 2.5× detergent composition comprising sugar amines. Formulation 7 is a 3× concentrated detergent composition corn rising sugar amines.

TABLE 4

| | Formulation 5 | Formulation 6 | Formulation 7 |
|---|---|---|---|
| Dose (g) | 23.51 g | 18.8 g | 15.6 g |
| Dose (fluid oz) | 0.75 | 0.60 | 0.50 |
| Water activity | — | 0.75 | 0.74 |
| Density (approximate, g/mL) | — | 1.11 | 1.1 |
| Viscosity (cP), approximate | — | 500 | 525 |
| pH | 8.1 | 8.1 | 8.0 |
| Concentration | 2x | 2.5x | 3x |
| Component | wt % in Formula | | |
| Glycerin | 38.87 | 35.71 | 31.86 |
| 25-7 Alcohol Ethoxylate Nonionic | 21.07 | 25.00 | 30.12 |
| Surfactant | | | |
| Water | 31.27 | 28.44 | 25.06 |
| Performance Polymer, | 2.57 | 3.2 | 3.85 |
| Iminodisuccinic Acid (34% | | | |
| active), Coconut Fatty acid, Citric | | | |
| Acid (50% solution), Sodium | | | |
| Hydroxide (50% Solution) | | | |
| AES Surfactant (70% Active) | 4.00 | 5.00 | 6.02 |
| Sodium Laureth Sulfate | | | |
| Glucosamine HCl | 0.5 | 0.5 | 0.5 |
| Protease, Amylase, and | 1.72 | 2.15 | 2.59 |
| Mannanase Solution | | | |

The target pH of the formulations 5-7 was 8. Citric acid and sodium hydroxide were used to adjust pH.

Target water activity was below 0.75. This water activity was achieved using a 55 to 45 ratio of glycerin to water. If a water activity of 0.7 or lower is desired, then a higher ratio of glycerin would be used. If a water activity of 0.8 is desired, a higher ratio of water would be used.

The formulas were designed to deliver the same amount of active material to the wash (in grams) such as surfactants and enzymes based on Formulations 1 and 2 (adding additional water and consolidating solvents to glycerin), so a mildness and stain removal performance are expected to be equivalent.

Additional solvents such as ethanol, glycol ether s can be added to lower (adjust) viscosity, if needed.

The target dose of detergent per wash is approximately 18.8 grams and the estimated amount of water in a high efficiency washing machine is 31.4 L. Proportionally, 0.6 grams of detergent will go into 1 L of water (benchtop scale).

With a starting chlorine concentration of 1 ppm in the water, the following results were gained after adding 0.6 grams of Formula 18 to 1 Liter of 1 ppm chlorinated water as seen in Table 5.

TABLE 5

| | Start | 15 | 30 | 1 | 2 |
|---|---|---|---|---|---|
| | ppm | seconds | seconds | minute | minutes |
| Control (formulation 6 | 1 | 1 | 1 | 0.5 | 0.5 |
| with no glucosamine) | | | | | |
| Formulation 6 | 1 | 0 | 0 | 0 | 0 |

It was observed that the addition of a sugar amine can scavenge chlorine and provide fabric care (color care) along with enzyme care (prevents from deactivating in the water) benefits.

Examples listed above utilize glucosamine HCl, glucose diamine, and sorbitol amine. However, the laundry detergent formulas listed here are not limited to these sugar amines.

What is claimed is:

1. A detergent composition comprising:
a sugar amine in an amount ranging from about 0.01 to about 2 wt % of the detergent composition;
a non-aqueous solvent in an amount ranging from about 20 to about 50 wt % of the detergent composition;
an alcohol ethoxylate non-ionic surfactant in an amount ranging from about 15 to about 40 wt % of the detergent composition; and
water,
wherein the detergent composition is free of propylene glycol and linear alkylbenzene sulfonates.

2. The detergent composition of claim 1, wherein the sugar amine is a sugar alcohol amine, a sugar diamine, a salt thereof, or any combination of any of the foregoing.

3. The detergent composition of claim 1, wherein the sugar amine is a sorbitol amine, a glucosamine, a glucose diamine, glucosamine HCl, a salt thereof, or any combination of any of the foregoing.

4. The detergent composition of claim 1, wherein the non-aqueous solvent is glycerin, a polyethylene glycol, a glycol ether, or any combination thereof.

5. The detergent composition of claim 1, wherein the sugar amine is in an amount ranging from about 0.25 to about 0.75 wt % of the detergent composition.

6. The detergent composition of claim 1, further comprising:
a strong base in an amount ranging from about 0.01 to about 2 wt % of the detergent composition;
a weak acid in an amount ranging from about 0.01 to about 2 wt % of the detergent composition;
a chelating agent in an amount ranging from about 0.1 to about 2.5 wt % of the detergent composition;
a lauryl sulfate or a lauryl ether sulfate in an amount ranging from about 2 to about 8 wt % of the detergent composition; and
a fatty acid in an amount ranging from about 0.5 to about 5 wt % of the detergent composition.

7. The detergent composition of claim 1, wherein detergent composition has a pH ranging from about 5 to about 12.

8. The detergent composition of claim 1, wherein detergent composition has a pH ranging from about 7 to about 11.5.

9. The detergent composition of claim 1, further comprising ethanol and/or one or more glycol ethers.

10. The detergent composition of claim 1, wherein the detergent composition has a water activity ranging from about 0.55 to about 0.85.

11. The detergent composition of claim 1, wherein the detergent composition has a water activity of less than 0.7.

12. The detergent composition of claim 1, wherein the detergent composition has a Zein score of less than 2%.

13. The detergent composition of claim 1, wherein the detergent composition has a Zein score of less than 0.5%.

14. The detergent composition of claim 1, further comprising a protease, an amylase and a mannanase.

15. The detergent composition of claim 14, wherein:
the protease is in an amount ranging from about 0.01 to about 2 wt % of the detergent composition;
the amylase is an amount ranging from about 0.01 to about 2 wt % of the detergent composition; and
the mannanase is in an amount ranging from about 0.01 to about 2 wt % of the detergent composition.

16. The detergent composition of claim 14, wherein the detergent composition has a pH ranging from about 6 to about 10.5.

17. The detergent composition of claim 14, wherein the detergent composition has a pH ranging from about 7 to about 9.

18. The detergent composition of claim 1, wherein
the non-aqueous solvent is in an amount ranging from about 30 to about 40 wt % of the detergent composition; and/or
the alcohol ethoxylate non-ionic surfactant is in an amount ranging from about 20 to about 35 wt % of the detergent composition.

19. The detergent composition of claim 1, wherein the detergent composition is free of preservatives.

20. A method of cleaning laundry, the method comprising:
combining an amount of the detergent composition of claim 1 with an amount of water to form a diluted detergent composition having from about 0.4 to about 0.8 grams of the detergent composition per liter of water; and
cleaning the laundry using the diluted detergent composition.
